(19) United States
(12) Patent Application Publication
(10) Pub. No.: US 2016/0341544 A1
(43) Pub. Date: Nov. 24, 2016

(54) MONITORING SYSTEM FOR DEPOSITION AND METHOD OF OPERATION THEREOF

(71) Applicant: APPLIED MATERIALS, INC., Santa Clara, CA (US)

(72) Inventor: Majeed Foad, Sunnyvale, CA (US)

(21) Appl. No.: 15/107,062

(22) PCT Filed: Dec. 19, 2014
(86) PCT No.: PCT/US2014/071684

§ 371 Date: Jun. 21, 2016

Related U.S. Application Data
(60) Provisional application No. 61/919,776, filed on Dec. 22, 2013.

(51) Int. Cl. G01B 11/06; G01B 15/02

(52) U.S. Cl. CPC G01B 11/0683; G01B 11/0625; G01B 15/02

(57) ABSTRACT

A monitoring system and method of operation thereof includes: providing a substrate on a platform; performing a scan of the substrate; depositing a material layer on the substrate; monitoring a deposition thickness of the material layer; and generating an alert based on an error in the deposition thickness.

### CROSS-REFERENCE TO RELATED APPLICATION(S)

This application is the national phase of PCT Application Serial No. PCT/US2014/071684, filed Dec. 19, 2014, which claims the benefit of U.S. Provisional Patent Application Ser. No. 61/919,776 filed Dec. 22, 2013, and the subject matter thereof is incorporated herein by reference thereto.

### TECHNICAL FIELD

The present invention relates generally to a monitoring system, and more particularly to a monitoring system for deposition systems in extreme ultraviolet lithography.

### BACKGROUND

Extreme ultraviolet lithography (EUVL, also known as soft x-ray projection lithography) is a contender to replace deep ultraviolet lithography for the manufacture of 0.13 micron, and smaller, minimum feature size semiconductor devices.

However, extreme ultraviolet light, which is generally in the 5 to 40 nanometer wavelength range, is strongly absorbed in virtually all materials. For that reason, extreme ultraviolet systems work by reflection rather than by transmission of light. Through the use of a series of mirrors, or lens elements, and a reflective element, or mask blank, coated with a non-reflective absorber mask pattern, the patterned actinic light is reflected onto a resist-coated semiconductor wafer.

The lens elements and mask blanks of extreme ultraviolet lithography systems are coated with reflective multilayer coatings of materials such as molybdenum and silicon. Reflection values of approximately 65% per lens element, or mask blank, have been obtained by using substrates that are coated with multilayer coatings that strongly reflect light essentially at a single wavelength within a extremely narrow ultraviolet bandpass; e.g., 12 to 14 nanometer bandpass for 13 nanometer ultraviolet light.

There are various classes of defects in semiconductor processing technology which cause problems in masks. Opaque defects are typically caused by particles on top of the multilayer coatings or mask pattern which absorb light when it should be reflected. Clear defects are typically caused by pinholes in the mask pattern on top of the multilayer coatings through which light is reflected when it should be absorbed.

Phase defects are typically caused by scratches and surface variations beneath the multilayer coatings which cause transitions in the phase of the reflected light. These phase transitions result in light wave interference effects which distort or alter the pattern that is to be exposed in the resist on the surface of the semiconductor wafer. Because of the shorter wavelengths of radiation which must be used for sub-0.13 micron minimum feature size, scratches and surface variations which were insignificant before now become intolerable.

While progress has been made in reducing or eliminating particle defects and work has been done on repair of opaque and clear defects in masks, to date nothing has been done to address the problem of phase defects. For deep ultraviolet lithography, surfaces are processed to maintain phase transitions below 60 degrees. Similar processing for extreme ultraviolet lithography is yet to be developed.

For an actinic wavelength of 13 nanometers, a 180 degree phase transition in the light reflected from the multilayer coating may occur for a scratch of as little as 3 nanometers in depth in the underlying surface. This depth gets shallower with shorter wavelengths. Similarly, at the same wavelength, surface variations more abrupt than one (1) nanometer rise over one hundred (100) nanometers run may cause similar phase transitions. These phase transitions can cause a phase defect at the surface of the semiconductor wafer and irreparably damage the semiconductor devices.

In the past, mask blanks for deep ultraviolet lithography have generally been of glass but silicon or ultra low thermal expansion materials have been proposed as alternatives for extreme ultraviolet lithography. Whether the blank is of glass, ultra low thermal expansion material, or silicon, the surface of the mask blank is made as smooth as possible by mechanical polishing with an abrasive. The scratches that are left behind in such a process are sometimes referred to as “scratch-dig” marks, and their depth and width depend upon the size of the particles in the abrasive used to polish the mask blank. For visible and deep ultraviolet lithography, these scratches are too small to cause phase defects in the pattern on the semiconductor wafer. However, for extreme ultraviolet lithography, scratch-dig marks are a significant problem because they will appear as phase defects.

Due to the short illumination wavelengths required for EUV lithography the pattern masks used must be reflective mask instead of the transmissive masks used in current lithography. The reflective mask is made up of a precise stack of alternating thin layers of molybdenum and silicon, which creates a Bragg refractor or mirror. Because of the nature of the multilayer stack and the small feature size, any imperfections in the surface of the substrate on which the multilayer stack is deposited will be magnified and impact the final product. Imperfections on the scale of a few nanometers can show up as printable defects on the finished mask and need to be eliminated from the surface of the mask blank before deposition of the multilayer stack.

Common imperfections include pits, scratches, and particles. Common cleaning techniques remove many of the particles but either generate new pits or amplify existing pits. The pits can come from the polishing or cleaning process or can be from inclusions or flaws in the substrate material itself that are exposed during the cutting and polishing process. Further polishing can be used to remove the pits at the surface, but there is a risk that new pits will be exposed or caused in the process, which limits the usefulness of using polishing alone to smooth and planarize the substrate surface. Another method for substrate smoothing is laser or plasma annealing. These techniques melt and reflow a thin surface layer of the glass substrate, removing local defects. The problem is that they induce longer range roughness or ripples in the substrate surface and so do not provide the substrate flatness required for EUV masks.

In view of the need for the increasingly smaller feature size of electronic components, it is increasingly critical that answers be found to these problems. In view of the ever-increasing commercial competitive pressures, along with growing consumer expectations, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

The present invention provides a method of operating a monitoring system including: providing a substrate on a platform; performing a scan of the substrate; depositing a material layer on the substrate; monitoring a deposition thickness of the material layer; and generating an alert based on an error in the deposition thickness.

The present invention provides a monitoring system including: a platform for supporting a substrate; a deposition system for depositing a material layer on the substrate; a sensor assembly for detecting an error in the material layer; and a second deposition system for depositing another of the material layer on the substrate.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is an integrated extreme ultraviolet mask production system.

FIG. 2 is an example view of a monitoring system for deposition and metrology in accordance with a first embodiment of the present invention.

FIG. 3 is an exemplary hardware block diagram of the sensor assembly.

FIG. 4 is an example view of a monitoring system for deposition and metrology in accordance with a second embodiment of the present invention.

FIG. 5 is the structures in FIG. 2 in an intermediate deposition phase.

FIG. 6 is an exemplary top view of the monitored substrate shown in FIG. 2.

FIG. 7 is a method of operation of the monitoring system of FIG. 2 in an embodiment of the present invention.

FIG. 8 is a method of operation of the monitoring system of FIG. 2 in a further embodiment of the present invention.

FIG. 9 is an EUV lithography system.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known components and circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

Where multiple embodiments are disclosed and described having some features in common, for clarity and ease of illustration, description, and comprehension thereof, similar and like features will be described with similar reference numerals.

For expository purposes, the term “horizontal” as used herein is defined as a plane parallel to the plane or surface of a mask blank or substrate, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures. The term “on” indicates that there is direct contact between elements.

The term “processing” as used herein includes deposition of material or photoresist, patterning, exposure, development, etching, cleaning, and/or removal of the material or photoresist as required in forming a described structure.

Embodiments of the present invention are for monitoring and creating layered devices that are within specification. A layered device can include mask blanks, mirrors, and electrical devices that include stacks of multiple layers of thin films. For example, the layered device can include magnetic ram (MRAM), extreme ultraviolet (EUV) mask blanks, extreme ultraviolet lithography (EUVL), X-ray mirrors, or other multi-layered reflective devices. The present invention includes a system and method for monitoring the uniform film thicknesses and interface quality during manufacture of the above mentioned devices.

The deposition system can include a sensor assembly for monitoring the thickness, uniformity, flatness, and interface quality of each of the film layers in layered devices. The sensor assembly can include a single sensor, multiple sensors in a single assembly housing, or multiple sensors in different locations within the deposition and manufacturing system.

The sensor assembly can also include a charge-coupled device (CCD), x-ray reflectors, EUV reflectors, laser scattering techniques, laser cathode sensors, or a combination thereof to monitor the thickness, interface sharpness, flatness, and the uniformity of the film layers. The precision of the sensors of the sensor assembly can include 0.10 of an Angstrom (Å).

The deposition system with the sensor assembly can monitor and display real-time information regarding the film thickness, film uniformity, interface sharpness, and surface smoothness of each material layer. The sensor assembly can also monitor for inter-diffusion between film layers and defects within the film layers. The sensor assembly can also monitor for defects and particles, such as gouges, groves, scratches, bundles, deformities, stones, boulders, and pits within and on each layer.

For example, the sensor assembly can use x-ray reflectivity, UV reflectance, and laser scattering techniques to monitor and characterize thickness uniformity, interface roughness, film composition, and detect particles using in-situ or inline detection for every individual deposited layer. During the forming or manufacturing stages, the embodiments of the present invention can monitor each layer for different compositions or elements. The sensor assembly can provide immediate feedback regarding the specifications of each layer.

One important inventive aspects described above is that fully constructed EUVL masks cannot be repaired and must be discarded if there are errors on the substrate or deposited layers. The precision needed in EUVL mask construction creates a very large selling price for defect-free masks. A system for layer-by-layer monitoring or step-by-step monitoring of the manufacture of layered device, such as an EUVL mask, improves the yield of producing good masks and elimination of waste used in construction of defective masks.

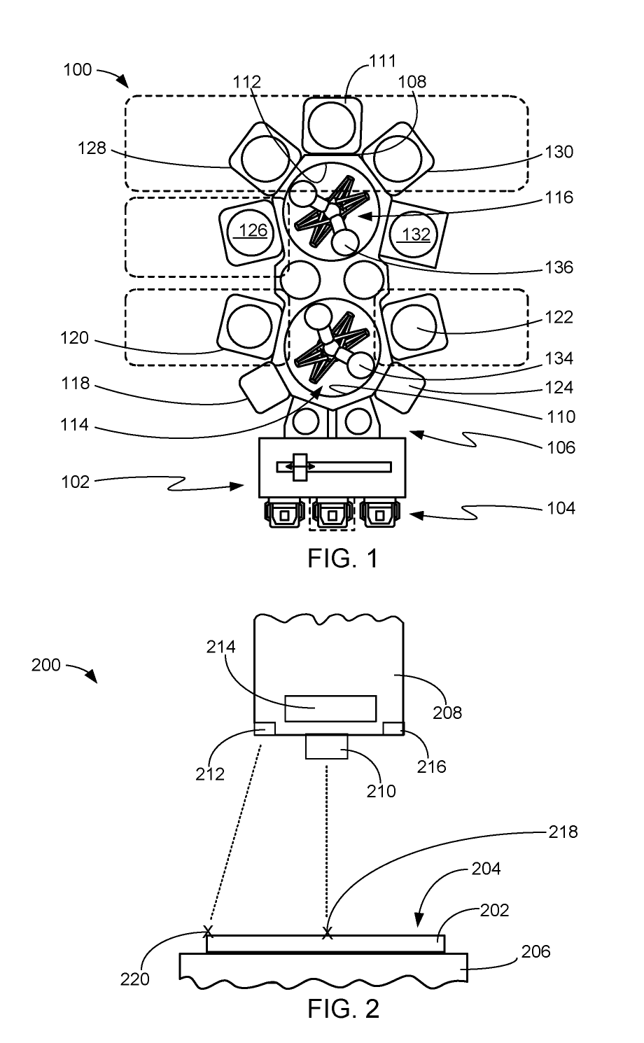

Referring now to FIG. 1, therein is shown an integrated extreme ultraviolet mask production system 100. The integrated EUV mask production system 100 includes a substrate loading and carrier handling system 102 into which a substrate 104 or substrates are loaded. An airlock 106 provides access to a wafer handling vacuum chamber 108. In the embodiment shown, the wafer handling vacuum chamber 108 contains two vacuum chambers, a first vacuum chamber 110 and a second vacuum chamber 112. Within the first vacuum chamber 110 is a first wafer handling system 114 and in the second vacuum chamber 112 is a second wafer handling system 116.

The wafer handling vacuum chamber 108 has a plurality of ports around its periphery for attachment of various other systems. The first vacuum chamber 110 has a degas system 118, a first physical vapor deposition system 120, a second physical vapor deposition system 122, an inspection chamber 111, and a preclean system 124. After deposition of the substrate 104, the substrate 104 can be transferred to the inspection chamber 111 for detection of defects and errors.

The second vacuum chamber 112 has a first multi-cathode source 126, a flowable chemical vapor deposition (FCVD) system 128, a cure system 130, and a second multi-cathode source 132 connected to it.

The first wafer handling system 114 is capable of moving wafers, such as a wafer 134, among the airlock 106 and the various systems around the periphery of the first vacuum chamber 110 and through slit valves in a continuous vacuum. The second wafer handling system 116 is capable of moving wafers, such as a wafer 136, around the second vacuum chamber 112 while maintaining the wafers in a continuous vacuum. It has been discovered that the integrated EUV mask production system 100 provides the ideal environment for manufacturing EUV masks.

Referring now to FIG. 2, therein is shown an example view of a monitoring system 200 for deposition and metrology in accordance with a first embodiment of the present invention. The monitoring system 200 can monitor the deposition process and metrology on a monitored substrate 202 for use in the creation of an EUVL mask, magnetic random access memory (MRAM) component, or other layered device.

The monitoring system 200 can be incorporated within the integrated extreme ultraviolet mask production system 100 of FIG. 1. For example, the first vacuum chamber 110 of FIG. 1 and the second vacuum chamber 112 of FIG. 1 can include the monitoring system 200. The monitoring system 200 can be mounted in various sub-chambers, such as the first physical vapor deposition system 120 of FIG. 1, the second physical vapor deposition system 122 of FIG. 1, the first multi-cathode source 126 of FIG. 1, the flowable chemical vapor deposition (FCVD) system 128 of FIG. 1, and the inspection chamber 111 of FIG. 1, as examples.

The monitored substrate 202 can include a base structure for forming an EUV mask blank. The monitored substrate 202 can be identical to the substrate 104 of FIG. 1. The monitored substrate 202 can include quartz, silicon, glass-ceramic, or other ultra-low expansion glass material. The monitored substrate 202 can include a substrate top surface 204.

The monitored substrate 202 can be mounted on a platform 206 or deposition chuck. The platform 206 can hold the monitored substrate 202 during a deposition or EUVL mask blank manufacturing process. The platform 206 can be stationary during the deposition process but the platform 206 can also include a rotation system to spin the monitored substrate 202. The rotation of the platform can assist with uniformity of deposition on the monitored substrate 202.

The monitoring system 200 can include a sensor assembly 208. The sensor assembly 208 is a housing or enclosure for a sensor or group of sensors. The sensors within the sensor assembly 208 can include active and passive sensors, charge-coupled device (CCD) cameras, visible light sensors, dark and bright field microscopes, x-ray reflectance systems, UV-EUV light reflectance systems, laser scattering systems, or a combination thereof. The sensor assembly 208 is shown as a single housing, but it is understood that the monitoring system 200 can also include multiple assemblies for housing a plurality of sensors.

For example, the sensor assembly 208 can include a first sensor 210 or main sensor and a second sensor 212. The first sensor 210 and the second sensor 212 can be used as a source, lamp, fiber source, diffuser, directional fiber, projection system, or a combination thereof for transmitting UV or x-ray beams for monitoring.

The sensor systems of the sensor assembly 208 can be fixed to be stationary within the deposition chambers of the integrated extreme ultraviolet mask production system 100. It has been discovered that the stationary placement of the sensors within the sensor assembly 208 reduces moveable parts that may generate particles and debris within the chamber.

For example, the sensor assembly 208 can include the first sensor 210 mounted directly above the monitored substrate 202 and can include a barrel, fiber, array, collimator, or combination thereof positioned for emitting radiation at an orthogonal or ninety-degree angle to the substrate top surface 204. The first sensor 210 can be positioned over a center location 218, which is a center point on the substrate top surface 204.

The second sensor 212 can be mounted adjacent to the first sensor 210. The source of the second sensor 212 is shown positioned at a forty-five degree angle to the substrate top surface 204, although the second sensor 212 can also be oriented at an orthogonal angle to the substrate top surface 204. For example, radiation can be emitted at a forty-five degree angle from the source to the substrate top surface 204.

For illustrative purposes, the second sensor 212 can be aligned towards or aimed at an edge location 220 at the substrate top surface 204, which is a point near the edge or end of the substrate top surface 204. However, the second sensor 212 can be aligned towards the center location 218 for monitoring a specular reflection from the center location 218.

The sensor assembly 208 can also include a third sensor 214 and a fourth sensor 216, which can be detectors. For example, the detectors can receive emissions or radiation from sources, such as the first sensor 210 and the second sensor 212. Detector sensor arrays, such as the third sensor 214 and the fourth sensor 216, can include CCD-base spectrometers, cameras, and microscopes. The third sensor 214 and the fourth sensor 216 can measure oscillations in wavelength from beams and radiation reflected of surfaces.

It has been discovered that the sensor assembly 208 can be used to monitor for defects, errors, and out of specification characteristics of components in an EUVL mask in real-time during construction. The sensors within the sensor assembly 208 can be used to characterize surfaces, thin films, and multilayers. For example, microscopes, reflectance systems, and cameras can be installed within the sensor assembly 208 to monitor the substrate top surface 204 for pits, surface roughness, particles, and other defects.

Further, it has been discovered that the monitoring system 200 can be implemented inline or in-situ into a physical vapor deposition (PVD), atomic layer deposition (ALD), and flowable CVD (FCVD) system or combination thereof. For example, the monitoring system 200 can be incorporated inline or in-situ within a deposition chamber, such as the first physical vapor deposition system 120. The monitoring system 200 can monitor surfaces and layer thickness in real time during an entire deposition process.

Monitoring can include charge-coupled device (CCD) cameras, visible light sensors, dark and bright field microscopes, x-ray reflectance systems, UV-visible light reflectance systems, laser scattering systems, or a combination thereof. Spectrometers can be used to analyze sensor readings such as scattering abnormalities and modulations in wavelengths. Abnormalities in controlled and predicated sample signatures would indicate defects on the surface and out of specification layer thickness levels.

Further, it has been found that the sensor assembly 208 can be used to monitoring thickness uniformity, interface roughness, and composition of layers deposited on the monitored substrate 202. After scanning and possible cleaning of the monitored substrate 202, layers of Mo and Si can be deposited on the monitored substrate 202 and each layer can be individually scanned for defects on the top of the layer surface. Each layer in the buildup can be scanned to ensure that the flatness, thickness, and uniformity are within specification.

It has been found that the monitoring system 200 can monitor and record characteristics of each deposited layer on the monitored substrate 202. Data and information from the sensor assembly 208 can be used to adjust the deposition process and model subsequent production cycles.

The sensor assembly 208 can include a system for x-ray reflectivity or x-ray reflectometry (XRR). Similar to ultraviolet-visible spectroscopy, x-ray beams can be reflected on the substrate top surface 204 to measure the intensity of beam reflected. If the substrate top surface 204 is out of specification, the reflected intensity will deviate from a predicted density profile. X-ray reflectivity and XRR can be used to determine out of specifications widths of one to two angstroms.

Instead of determining defects after the completion of an EUVL mask blank or MRAM, each deposited layer can be scanned continuously or after deposition of each layer. Thus, it has been discovered that yield can be increased in the creation of EUVL masks and MRAM components by the elimination of wasted time and materials spent on a completed mask having a defect. For example, an EUVL mask can include 85 to 90 different deposition layers, which may require hours of deposition time. A starting defective substrate can be removed or cleaned before a time consuming and expensive deposition process is started. Further time and materials are conserved by monitoring each deposited layer on the monitored substrate 202, where the deposition process can be halted if a defect is found.

Further, it has been found that the method of continuous or layer-by-layer monitoring provides accurate and precise scanning of each deposited layer from using green light or a wavelength of 495 nm to 570 nm. The green light can be used to only monitor each deposited surface, which would indicate exactly which layer or width included a defect. This provides advantages over other wavelengths with deeper penetration, as the defect could have occurred within any layer of the general area of the penetration depth.

It has also been discovery that the continuous or layer-by-layer monitoring can be used to tune or adjust the deposition process. The monitoring can be used to detect historic deposition trends of the deposition machine and be used to adjust deposition times for each layer deposited.

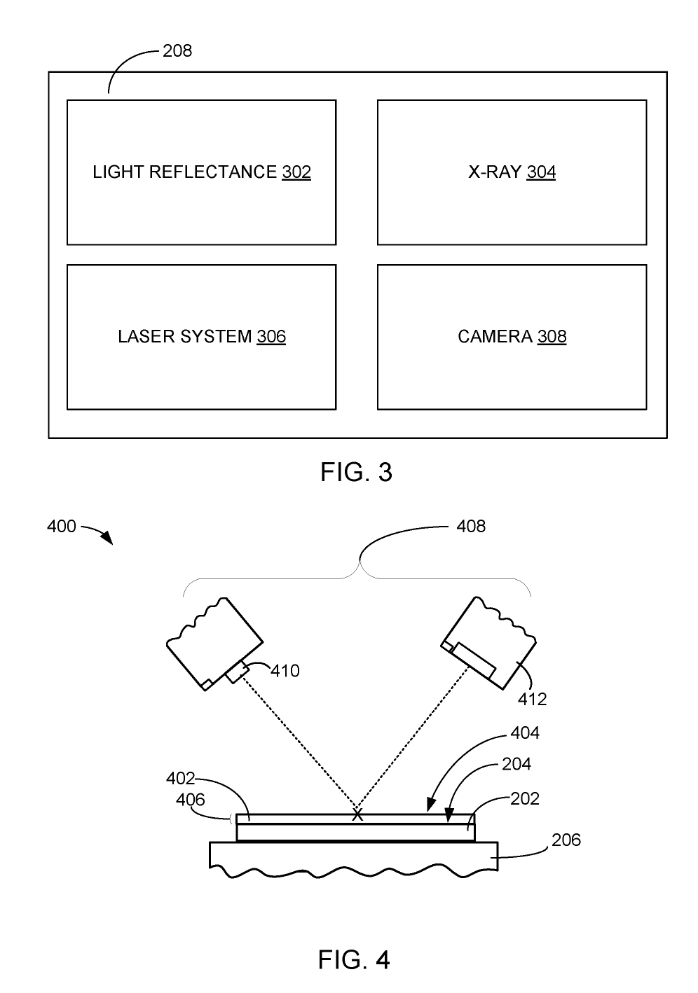

Referring now to FIG. 3, therein is shown an exemplary hardware block diagram of the sensor assembly 208. The sensor assembly 208 can include a plurality of inspection tools such as a light reflectance system 302, an x-ray system 304, a laser system 306, and a camera system 308. For illustrative purposes, the inspection tools and sensor systems of the sensor assembly 208 are described as a discrete system, although it is understood that these systems can function in conjunction with each other and utilize the same hardware.

The light reflectance system 302 is a system that can use ultraviolet or visible light for characterizing surfaces, thin films, and multilayers. For example, the light reflectance system 302 can be used to detect amplitude and phase shifts, when reflecting light off the surface of substrates and layers. The light reflectance system 302 can include using wavelengths of 10 nanometers (nm) to 600 nm including green light and EUV light.

The light reflectance system 302 can include spectroscopy methods and systems such as ultraviolet-visible spectroscopy or ultraviolet-visible spectrophotometry. For example, the light reflectance system 302 can include an objective base microscope operating in dark field with an EUV produced plasma source.

The light reflectance system 302 can use the first sensor 210 of FIG. 2, the second sensor 212 of FIG. 2, the third sensor 214 of FIG. 2, the fourth sensor 216 of FIG. 2, or a combination thereof as components for sources and detectors. For example, the first sensor 210 can be the source of an ultraviolet-visible spectroscopy system and the third sensor 214 can be a detector.

The x-ray system 304 includes sensors that utilize x-ray reflectivity or x-ray reflectometry. X-ray beams are projected or reflected from the source to a surface, such as the substrate top surface 204 of FIG. 2. The intensity of the reflected x-rays are measured and analyzed. For example, if the surface is not sharp and smooth, then the reflected intensity will deviate from what is predicted by the law of Fresnel reflectivity. The deviations can then be analyzed to obtain the density profile of the interface normal to the surface.

The x-ray system 304 can project and detect sensor readings using the sensors housed by the sensor assembly 208. For example, the x-ray system 304 can use the first sensor 210, the second sensor 212, the third sensor 214, the fourth sensor 216, or a combination thereof as components for sources and detectors.

The laser system 306 includes sensors that can utilize laser reflectance interferometry and spectroscopy to determine the thickness and smoothness of a surface. The laser system 306 can be similar in operation to the light reflectance system 302 and the x-ray system 304. For example, the laser system 306 can include a 405 nm laser diode as a source to be reflected onto a detector.

The camera system 308 can include other inspection tools not utilized in the other systems included within the sensor assembly 208. The camera system 308 can include a CCD camera, CCD based microscopes, ion-beam/scanning electron microscope (FIB/SEM), bright field or dark field configurations, transmission electron microscope (TEM), atomic force microscope (AFM), or a combination thereof.

The light reflectance system 302, the x-ray system 304, the laser system 306, and the camera system 308 can be incorporated in the same chamber or different chambers. For example, the light reflectance system 302 can be incorporated in a deposition chamber, such as the first physical vapor deposition system 120 of FIG. 1. The x-ray system 304 can be incorporated in the inspection chamber 111. It has been found that the substrate 104 of FIG. 1 can be removed from a deposition chamber and transferred to the inspection chamber 111 of FIG. 1 with the x-ray system 304 for monitoring each deposited layer.

Referring now to FIG. 4, therein is shown an example view of a monitoring system 400 for deposition and metrology in accordance with a second embodiment of the present invention. The example view can include a material layer 402 from an application or deposition process.

The material layer 402 can include a film or material deposited on the monitored substrate 202 and above the platform 206. For example, the material layer 402 can include a planarization layer, molybdenum (Mo), silicon (Si), or other material used in the creation of an EUVL mask. The first layer of the material layer 402 can be deposited directly on the substrate top surface 204.

The material layer 402 can include a layer top surface 404 and a deposition thickness 406. The layer top surface 404 is the top surface of the uppermost example of the material layer 402 that is deposited on the monitored substrate 202. For example, the layer top surface 404 is the top surface of a first layer deposited on the monitored substrate 202.

For illustrative purposes, if the ninetieth layer on the monitored substrate 202 is the uppermost layer, it is understood that the layer top surface 404 would be the current top surface of the ninetieth layer. The deposition thickness 406 is the width or thickness of the material layer 402. For example, the deposition thickness 406 of a silicon layer on the monitored substrate 202 can be 3-4 nm thick.

The monitoring system 400 can include a sensor assembly 408 oriented at a forty-five degree angle to the layer top surface 404 and the substrate top surface 204. For example, the sensor assembly 408 can include a source 410 positioned on a left side of the chamber and a detector positioned on the right side of the chamber. The example view shows radiation reflected off the layer top surface 404 at a forty-five degree angle and received at a detector 412.

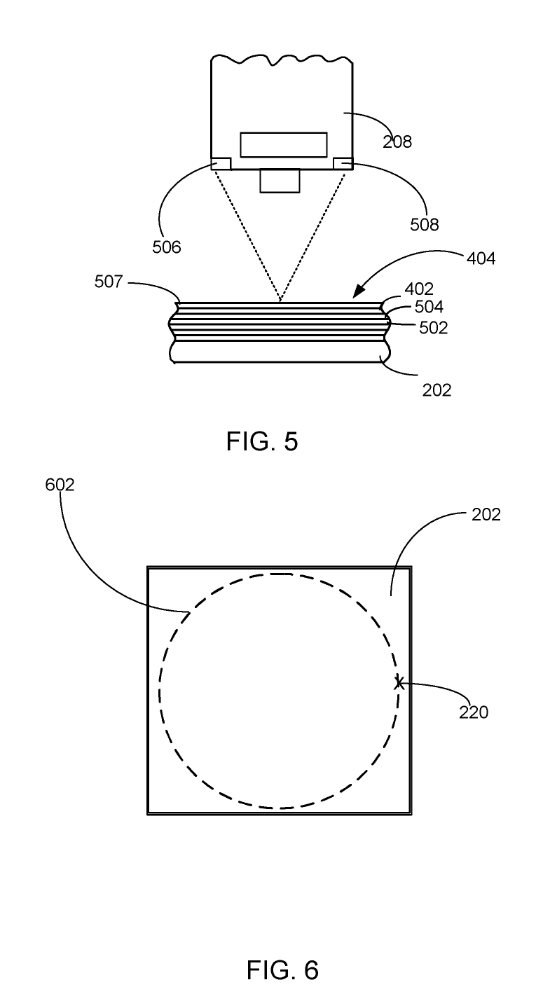

Referring now to FIG. 5, therein is shown the structures in FIG. 2 in an intermediate deposition phase. The example view can show a multi-layer stack deposited on the monitored substrate 202. The example view can include the monitored substrate 202, the material layer 402, the layer top surface 404, an internal silicon layer 502, and an internal molybdenum layer 504, and a second material layer 507.

The second material layer 507 is deposited on top of the material layer 402. The layer top surface 404 is the top surface of the second material layer 507 because the second material layer 507 is the uppermost deposited layer. The example view can include a source 506 and a detector 508 housed within a single assembly, such as shown in the sensor assembly 208 of FIG. 2. The source 506 and the detector 508 can be oriented to reflect and receive radiation at a forty-fixe degree angle off the layer top surface 404.

Referring now to FIG. 6, therein is shown an exemplary top view of the monitored substrate 202 shown in FIG. 2. The monitored substrate 202 can be supported by the platform 206 of FIG. 2. For illustrative purposes, the monitored substrate 202 is shown as a square although it is understood that the monitored substrate 202 can be produced from a circular wafer.

The exemplary top view can include the edge location 220 as shown in FIG. 2. The sensor assembly 208 of FIG. 2 can receive spectral signature and density profile information from the edge location 220. The monitored substrate 202 can be mounted on a rotating electrostatic chuck during the deposition process.

The exemplary top view can include an outer circumference 602 based on sensor readings from the edge location 220 on a rotating electrostatic chuck. Because of the rotation, the outer circumference 602 can provide spectral signature and density profile information for the circumference of the monitored substrate 202 or the material layer 402 of FIG. 4.

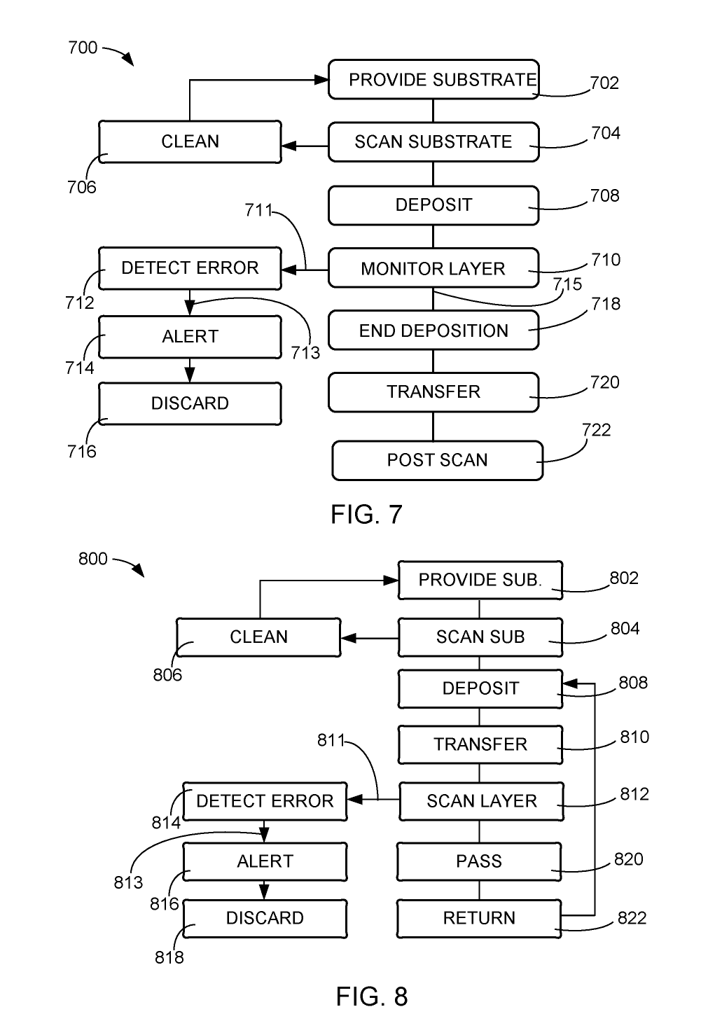

Referring now to FIG. 7, therein is shown a method 700 of operation of the monitoring system 200 of FIG. 2 in an embodiment of the present invention. The method 700 can include providing the monitored substrate 202 of FIG. 2 in a block 702. The monitored substrate 202 can be placed on the platform 206 of FIG. 2, which can include a rotating electrostatic chuck.

The monitored substrate 202 can be scanned with the sensor assembly 208 of FIG. 2 in a block 704. The scan can include any of the active, passive, or reflectance systems described in FIG. 3 for detecting defects and particles, such as gouges, groves, scratches, bundles, deformities, stones, boulders, and pits on the substrate top surface 204 of FIG. 2. If any defects are detected, the monitored substrate 202 can be cleaned or replaced in a block 706. The process can return to the block 702 for a restart using a defect free substrate.

After scanning for a defect free substrate, the material layer 402 can be formed or applied over the monitored substrate 202 in a block 708 or deposition process. The deposition of the material layer 402 can include CVD, PLD, ALD, and FCVD methods to deposit the material layer 402 over the monitored substrate 202.

The material layer 402 can be monitored during the deposition process in a block 710. The monitoring during the block 710 can include a continuous scan or a scan after completion of the deposited layer. The monitoring of the material layer 402 can be continuous during the entire deposition process. A continuous scan or a layer-by-layer scan of the material layer 402 can produce a spectral signature 715 and density profile for each layer. It has been found that the spectral signature 715 and density profile for each of the material layer 402 can be recorded for analysis and tuning of the deposition machine.

Alternatively, the material layer 402 can be scanned and monitored after completion of each layer. For example, the material layer 402 can be scanned after completion of a silicon layer, a molybdenum layer, or a Mo/Si pair. After deposition of another of the material layer 402, the layer top surface 404 of FIG. 4 can be scanned and so forth depending of the number of layers deposited on the monitored substrate 202.

During monitoring of the material layer 402 during deposition, an error 711 can be detected in a block 712. The error 711 is defined as defect in the material layer 402. The error 711 can be the result of an out of specification condition in the thickness uniformity, surface roughness, interface roughness, composition, and any particles found during the deposition process of an individual layer.

An alert 713 based on the error 711 of the material layer 402 can be generated in a block 714. The alert 713 can include a report with the density profile and spectral signature information of the material layer 402, which produced the error 711.

The defective substrate or mask blank sample can be discarded in a block 716. It has been found that a defectively deposited substrate or mask blank sample can be discarded at the time of deposition error of an individual layer instead of after completion of the entire mask. The layer-by-layer monitoring provided by the monitoring system 200 increases yield of defect free EUVL mask blanks by reducing the amount of time and materials wasted on a defective sample.

If the monitoring process does not detect any defects or errors during deposition, the deposition process can end in a block 718. The sample after the completed deposition process can be transferred into another chamber for further deposition or manufacturing steps in a block 720. The EUVL mask sample also can be transferred into the inspection chamber 111 of FIG. 1 for a post completion scan in a block 722.

Referring now to FIG. 8, therein is shown a method 800 of operation of the monitoring system 200 of FIG. 2 in a further embodiment of the present invention. The method 800 can include providing the monitored substrate 202 of FIG. 2 in a block 802. The monitored substrate 202 can be placed on the platform 206 of FIG. 2, which can include a rotating electrostatic chuck.

The monitored substrate 202 can be scanned with the sensor assembly 208 of FIG. 2 in a block 804. The scan can include any of the reflectance systems described in FIG. 3 for detecting defects and particles, such as gouges, groves, scratches, bundles, deformities, stones, boulders, and pits on the substrate top surface 204 of FIG. 2. If any defects are detected, the monitored substrate can be cleaned or replaced in a block 806. The process can return to the block 802 for restarting the process using a defect free substrate.

After scanning a defect free substrate, the material layer 402 can be formed or applied over the monitored substrate 202 in a block 808 or deposition process. The deposition of the material layer can include can include CVD, PLD, ALD, and FCVD methods to deposit the material layer 402 over the monitored substrate 202.

After deposition of the material layer 402 or deposition of a pair of layers, such as Si and Mo, the substrate sample can be transferred to an inspection chamber in a block 810. The material layer 402 or Si/Mo layer pair can be scanned for defects and errors in a block 812.

During monitoring of the material layer 402 during deposition, an error 811 can be detected in a block 814. The error 811 is defined as defect in the material layer 402. The error 811 can be the result of an out of specification condition in the thickness uniformity, surface roughness, interface roughness, composition, and any particles found during the deposition process of an individual layer.

An alert 813 based on the error 811 can be generated in a block 816 after the detection of the error 811. The alert 813 can include a report with the density profile and spectral signature information of the material layer 402, which produced the error 811. The defective substrate or mask blank sample can be discarded in a block 818.

The material layer 402 can pass the scan, which indicates that the thickness uniformity, surface roughness, interface roughness, composition, and any particles are within specification and are within pre-determined tolerance levels in a block 820. If passing specification parameters, the monitored substrate 202 or EUVL mask sample can be returned to the deposition chamber to continuous deposition of the other layers of the multi-layer in a block 822.

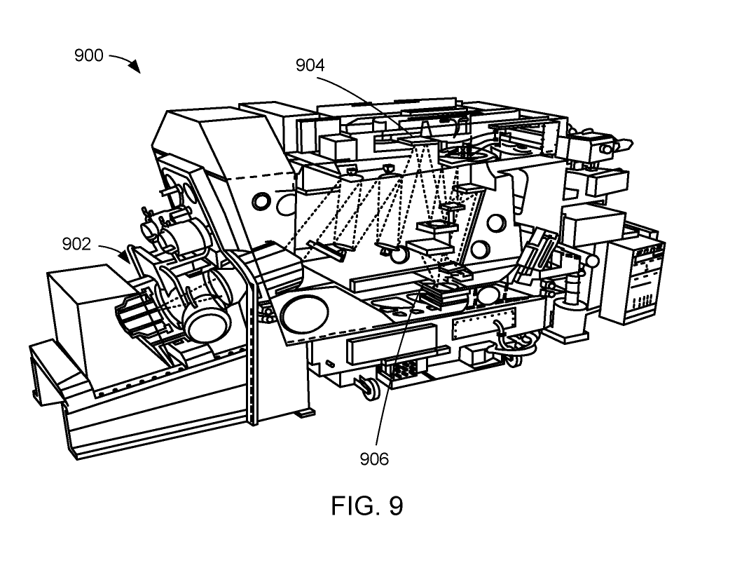

Referring now to FIG. 9, therein is shown an EUV lithography system 900. The EUV lithography system 900 includes an EUV light source area 902, a reticle stage 904 and a wafer stage 906. EUVL masks, created by the integrated extreme ultraviolet mask production system 100 of FIG. 1 and the monitoring system 200, can be utilized into the EUV lithography system 900.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a monitoring system comprising:
providing a substrate on a platform;
performing a scan of the substrate;
depositing a material layer on the substrate;
monitoring a deposition thickness of the material layer; and
generating an alert based on an error in the deposition thickness.

2. The method as claimed in claim 1 wherein monitoring the deposition thickness includes performing a continuous scan during a deposition process.

3. The method as claimed in claim 1 wherein monitoring the deposition thickness includes scanning with a wavelength of 495 nm to 570 nm.

4. The method as claimed in claim 1 wherein monitoring the deposition thickness includes monitoring a spectral signature of the material layer.

5. The method as claimed in claim 1 further comprising:
depositing a second material layer on the material layer; and
wherein:
monitoring the deposition thickness includes a continuous scan of the material layer and the second material layer.

6. A monitoring system comprising:
a platform for supporting a substrate;
a deposition system for depositing a material layer on the substrate;
a sensor assembly for detecting an error in the material layer; and
a second deposition system for depositing another of the material layer on the substrate.

7. The system as claimed in claim 6 wherein the platform can include an electrostatic chuck, a rotating chuck, or a combination thereof.

8. The system as claimed in claim 6 wherein the sensor assembly includes a light reflectance system, an x-ray system, a laser system, a camera system, or a combination thereof.

9. The system as claimed in claim 6 wherein the sensor assembly can include a source and a detector, the source and the detector are orientated in a forty-five degree angle to a layer top surface of the material layer.

10. The system as claimed in claim 6 further comprising an inspection chamber for scanning a deposition thickness after deposition of the material layer.

11. A method of operation of a monitoring system comprising:
providing a substrate on a platform, the platform includes a rotating electrostatic chuck;
performing a scan of the substrate;
depositing a material layer on the substrate;
monitoring a deposition thickness of the material layer; and
generating an alert based on an error in the deposition thickness or a defect in the substrate.

12. The method as claimed in claim 11 wherein performing the scan of the substrate includes performing the scan with a light reflectance system, an x-ray system, a laser system, a camera system, or a combination thereof.

13. The method as claimed in claim 11 wherein monitoring the deposition thickness includes transferring the substrate to an inspection chamber.

14. The method as claimed in claim 11 wherein monitoring the deposition thickness includes scanning a center location and an edge location.

15. The method as claimed in claim 11 wherein monitoring the deposition thickness includes scanning with a light reflectance system.
